(19) United States
(12) Patent Application Publication
(10) Pub. No.: US 2015/0213196 A1
(43) Pub. Date: Jul. 30, 2015

(54) SYSTEM AND METHOD FOR SECURE OPERATION OF A MEDICAL RECORDS REPORTING SYSTEM

(71) Applicants: Chester HEATH, Boca Raton, FL (US); Pedro MARTINEZ, Boca Raton, FL (US)

(72) Inventors: Chester HEATH, Boca Raton, FL (US); Pedro MARTINEZ, Boca Raton, FL (US)

(21) Appl. No.: 14/588,474

(22) Filed: Jan. 2, 2015

Related U.S. Application Data
(63) Continuation of application No. 12/506,545, filed on Jul. 21, 2009, now abandoned.
(60) Provisional application No. 61/083,025, filed on Jul. 23, 2008.

(51) Int. Cl. G06F 19/00

(52) U.S. Cl. CPC G06F 19/322; G06F 19/323; G06F 19/3418

(57) ABSTRACT

A system for accessing, updating, and maintaining health records of a medical data and reporting system. The system can comprise one or more data processors and a module configured to execute on the one or more data processors. The module can be configured to validate a particular user based upon patient identifying information, where the module is further configured to obtain patient identifying information from one or more computer-readable mediums, a voice response system, a mobile device, a global positioning system, and a biometric system. Additionally, the module can be configured to enable the user to securely access the medical data and reporting system and to report the data to the user.

### CROSS-REFERENCE TO RELATED APPLICATIONS

This application claims the benefit of U.S. Provisional Patent Application No. 61/083,025, which was filed Jul. 23, 2008, and which is incorporated herein in its entirety.

### FIELD OF THE INVENTION

The present invention is related to the field of data processing, and more particularly, to computer-based systems and methods for enabling multiple modes of secure operation and access of medical records and/or information.

### BACKGROUND OF THE INVENTION

A great challenge in today's data-centric society is providing the secure availability of up-to-date data. The challenge is particularly acute for physicians and other healthcare professionals. Often times, physicians and emergency personnel need to treat patients in critical situations without knowing or being able to access the patient's medical history. For example, in the event that a particular patient is unconscious or similarly debilitated, it is of the utmost importance that the physician or emergency personnel treating the patient tend to the patient quickly to prevent permanent health consequences or even death. In doing so, however, some of the treatments performed in trying to save the person's life might not be the proper treatments for that particular patient. As a result, those treating patients can unintentionally cause the patient to experience unwanted complications, a worsening of existing illnesses or diseases, or, in a worst case scenario, death. If treating personnel have multiple modes of secure access to the patient's most current medical history and/or other information during such situations, the patient will greatly benefit by receiving the treatment most suited to him or her. Such access to patient medical history will reduce costs, malpractice, unnecessary medical procedures, and increase patient confidence.

As a result, there is a need for more effective and efficient means of providing up-to-date, secure modes of accessing data. Furthermore, there is a need for effective and efficient methods and systems to enable multiple modes of secure operation and access of medical records and/or information.

### SUMMARY OF THE INVENTION

The present invention is directed to systems and methods for enabling multiple modes of secure operation and access of medical records, information, and reporting systems. The invention also entails accessing, updating, and maintaining health records of a medical data and reporting system.

One embodiment of the invention is a system for accessing, updating, and maintaining health records of a medical data and reporting system. The system can comprise one or more data processors and a module configured to execute on the one or more data processors. The module can be configured to validate a particular user based upon patient identifying information, where the module is further configured to obtain patient identifying information from one or more computer-readable mediums, a voice response system, a mobile device, a global positioning system, and a biometric system. Additionally, the module can be configured to enable the user to securely access the medical data and reporting system and to report the data to the user.

Another embodiment of the invention is a computer-based method for accessing, updating, and maintaining health records of a medical data and reporting system. The method can include validating a particular user using at least one among a readable medium containing patient identifying information, a voice response system, a mobile device, a global positioning system, and a biometric system. The method can also include enabling the user to securely access the medical data and reporting system. The method can further include reporting the medical data to the user.

Yet another embodiment of the invention is a computer-readable storage medium which contains computer-readable code that when loaded on a computer causes the computer to validate a particular user using at least one among a computer-readable medium containing patient identifying information, a voice response system, a mobile device, a global positioning system, and a biometric system. The computer-readable storage medium can also cause the computer to enable the user to securely access the medical data and reporting system and report the medical data to the user.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for accessing, updating, and maintaining health records of a medical data and reporting system, according to one embodiment of the invention.

FIG. 2 is an illustration of a computer-readable medium according an embodiment of the invention.

FIG. 3 is a an illustration of a mobile device according to an embodiment of the invention

FIG. 4 is a view of an embodiment of the system for accessing, updating, and maintaining health records of a medical data and reporting system.

FIG. 5 is a flowchart of steps in a method for accessing, updating, and maintaining health records of a medical data and reporting system, according to another embodiment of the invention.

### DETAILED DESCRIPTION

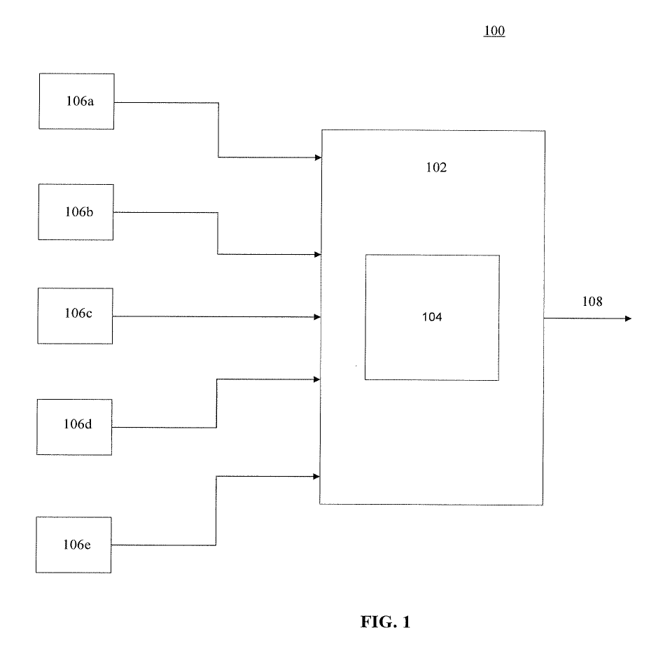

Referring initially to FIG. 1, a system 100 for accessing, updating, and maintaining health records of a medical data and reporting system, according to one embodiment of the invention is schematically illustrated. The system 100 can include one or more data processors 102 and a module 104 configured to execute on the one or more data processors 102. The system 100 can also include information sources 106a-e. Even though five information sources 106a-e are shown, it will be apparent to one of ordinary skill based on the description that a greater or lesser number of information sources can be utilized.

As shown, the information sources 106a-e are communicatively linked to the module 104. The module 104, which, if implemented as computer-readable code, is configured to execute on the one or more data processors 102. Alternatively, in another embodiment, the information sources 106a-e can communicatively link to the module 104 through a data communications network (not explicitly shown). The data communications network can be a local-area network (LAN), wide-area network (WAN), or the Internet.

Alternatively, the module 104 can be implemented in hardwired, dedicated circuitry for performing the operative functions described herein. In another embodiment, the module 104 can be implemented in computer-readable code configured to execute on a particular computing machine. In yet another embodiment, however, the module 104 can be implemented in a combination of hardwired circuitry and computer-readable code.

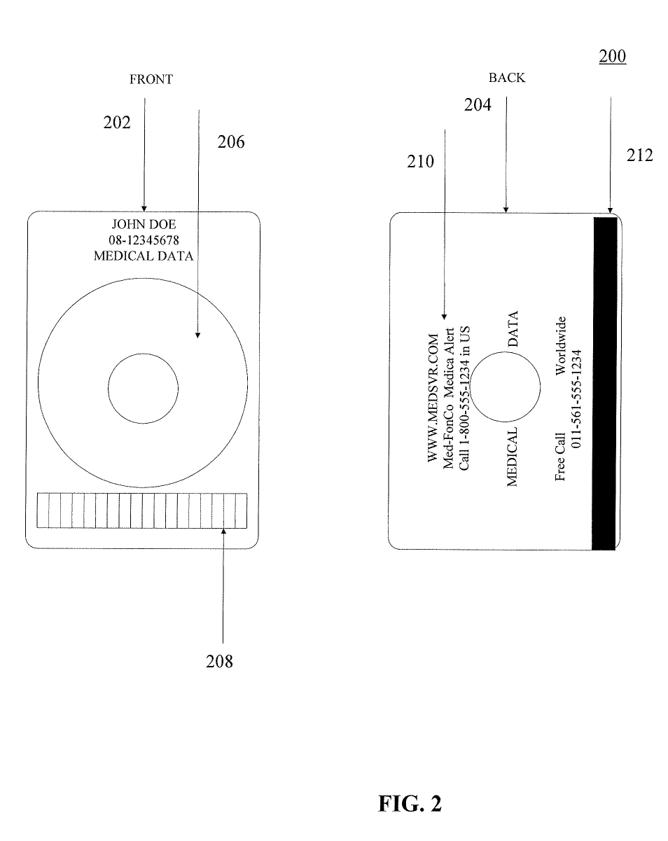

The module 104 can obtain patient identifying information from the information sources 106a-e. As previously mentioned, the number of information sources contained in the system 100 can be greater or fewer than the quantity illustrated in FIG. 1. The information sources 106a-e can include a computer-readable medium, a voice response system, a mobile device, a global positioning system and a biometric system. The computer-readable medium can comprise an optically readable disk, barcode, magnetic strip, radio frequency emitter, or other like computer-readable medium, with each containing a patient identifier along with patient identifying information, medical history, or other information. With reference now also to FIG. 2, a computer-readable medium 200 is illustrated. The computer-readable medium 200 can feature a front 202 and a back 204 and an optically readable disk 206. The optically readable disk 206 can contain some medical history, patient identifying information, and other sensitive data. Also, the computer-readable medium 200 can also include a barcode 208 and printed patient information 210, which could contain similar information as the optically readable disk 206. The computer-readable medium 200 can further include a magnetic strip 212, which contains patient data.

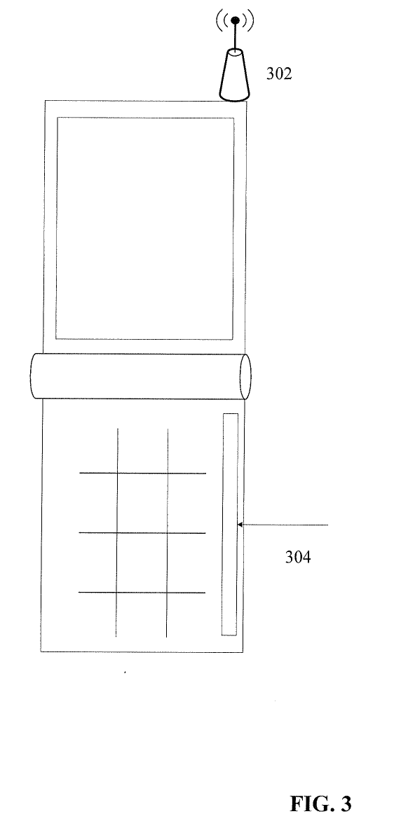

The mobile device can include a reader selected from one or more of a barcode reader, magnetic stripe reader, and a radio frequency reader, wherein the reader can identify and authorize those requesting data and transmit information, thereby enabling dual trusted paths of communication. The mobile device can also include one or more of a barcode, magnetic, stripe, radio frequency tag, or other computer-readable medium, wherein the barcode, magnetic stripe, radio frequency tag, or other computer-readable medium can identify a particular patient. With reference now also to FIG. 3, a mobile device 300 is illustrated. The mobile device 300 can include a barcode, magnetic stripe, or other reader 302 for reading various forms of media containing patient identifying information. Additionally, the mobile device 300 can include a barcode, magnetic stripe or other computer-readable medium 304 so as to provide dual trust paths of connectivity.

Operatively, the module 104 validates a particular user based upon patient identifying information by obtaining information from the information sources 106a-e. The type of data obtained by the module 104 comprises data pertaining to a particular patient such as age, name, phone number, medical history, and other types of relevant data. It is also important to note that the data is not restricted to medical data, but can be any type of data. After obtaining the requisite information from the user, the module 104 enables the user to securely access the medical data and reporting system. Once the user decides what he or she wants to access, the module 104 can then report 108 the requested medical data to the user.

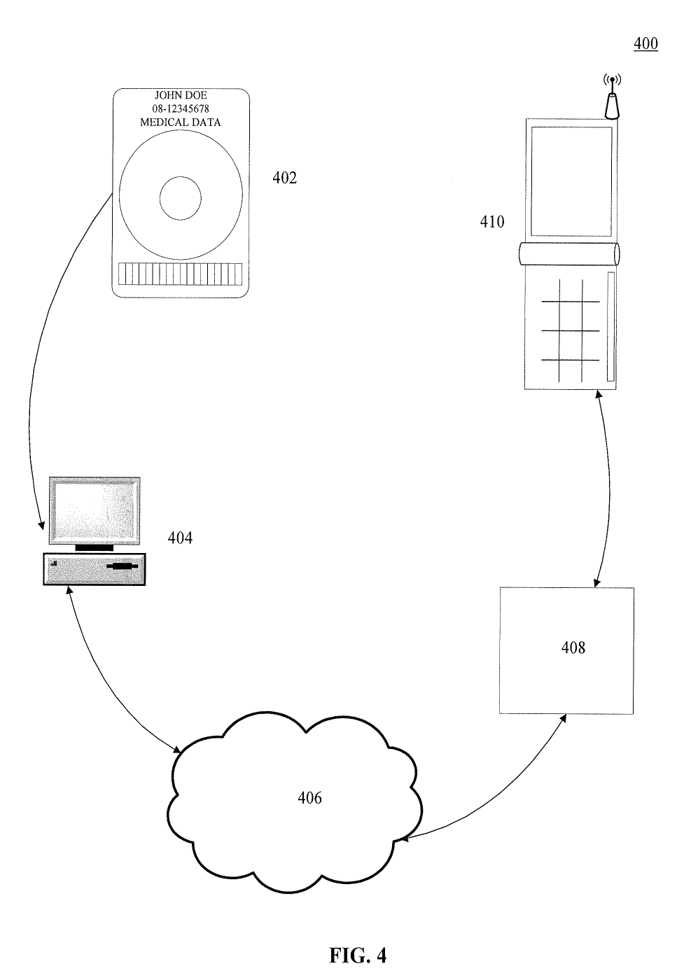

The module 104 can be configured to communicate with a mobile device enabled with caller identification (CID), where the CID is matched to a particular user's password and to a patient identifier contained within a computer-readable medium so that the user can access data contained within the mobile device. For example, referring now to the embodiment 400 of the system 100 illustrated in FIG. 4, the module 104 can be configured to execute on one or more data processors 408. The one or more data processors 408 can be communicatively linked to a computer-readable medium 402, containing patient identifying information via a computing device 404. The computing device 404 can relay the patient identifying information to the one or more data processors 408, where the module 104 resides, through a data network 406 or other network. The one or more data processors 408 can also be communicatively linked to a mobile device 410, which also contains patient identifying information and CID.

Operatively, for one trusted path, a call can be originated from an individual's mobile device 410, which has a CID. The module 104 contained within the one or more data processors 408 can validate the user by comparing the CID to its records. For a second path, a computer-readable medium 402, containing a patient identifier, can be read by a computing device 404, which can then communicate with the one or more data processors 408 through the network 406. The one or more data processors 408 can match the patient identifier from the computer-readable medium 402 to its records. If both the identifier from the mobile device 410 and the identifier from the computer-readable medium 402 match the one or more data processors' records and/or the user's password, then the user can gain access to the data processor 408 and to data contained within the mobile device 410.

According to an embodiment, the module 104 can be configured to communicate with a voice response system, where the voice response system receives a patient identifier printed on a computer-readable medium to enable access to the user. For example, when a user lacks other means to access the system 100, the user can dial a call, which connects the user to the voice response system. The voice response system can then validate the user and send patient identifying information to the user.

In another embodiment of the invention, the module 104 can be configured to validate a user by receiving a call from a user, where the user provides one or more of a patient identifier, caller identifier, and hospital identifier over the telephone. Using CID, the module 104 can determine that the call does originate from an authorized list of numbers. Also, if the identifier matches an authorized number and/or the hospital identifier, the module 104 can release requested data through a portal using the patient identifier and originating phone number as a password.

The module 104 can also validate a user by the user's geographical location and/or biometric data. According to yet another embodiment, the module 104 can be further configured to periodically update data contained within a mobile device and/or the system 100.

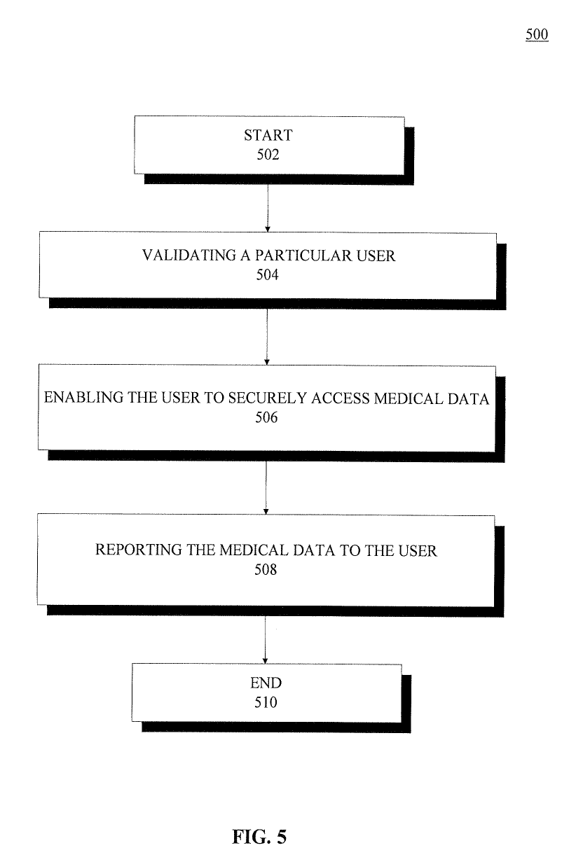

Referring now to FIG. 5, a flowchart is provided that illustrates certain method aspects of the invention. The flowchart depicts steps of a method 500 for accessing, updating, and maintaining health records of a medical data and reporting system. The method 500 illustratively includes, after the start step 502, validating a particular user using at least one among a computer-readable medium containing patient identifying information, a voice response system, a mobile device, a global positioning system, and a biometric system at step 504. The method 500 also includes enabling the user to securely access the medical data and reporting system at step 506. Additionally, the method 500 includes at step 508 reporting the medical data to the user. The method 200 illustratively concludes at step 510.

The method 500 can also include validating a particular user using a mobile device enabled with caller identification (CID), where the CID is matched to a user password and to a patient identifier contained within a computer-readable medium so that a user can access data within the mobile device. Also, the method 500 can include validating a particular user using a voice response system, where a user communicates a patient identifier printed on a computer-readable medium to the voice response system. The voice response system then communicates with the medical data and reporting system so as to enable access to the user. The method 500 can further include validating a particular user by having a user call a contact number and providing one or more of a patient identifier, caller identifier, and a hospital identifier, where the patient identifier, caller identifier, and hospital identifier can be matched by the medical data and reporting system so as to enable access to the user.

According to another embodiment, the method 500 can further include periodically updating data contained within the mobile device and/or the medical data and reporting system.

The various embodiments described herein can be adapted to serve other kinds of purposes, such as providing dual path security for retail credit purchasing, controlling delivery of items in transit, and other such purposes.

The invention, as already mentioned, can be realized in hardware, software, or a combination of hardware and software. The invention can be realized in a centralized fashion in one computer system, or in a distributed fashion where different elements are spread across several interconnected computer systems. Any type of computer system or other apparatus adapted for carrying out the methods described herein is suitable. A typical combination of hardware and software can be a general purpose computer system with a computer program that, when being loaded and executed, controls the computer system such that it carries out the methods described herein.

The invention, as already mentioned, can be embedded in a computer program product, such as magnetic tape, an optically readable disk, or other computer-readable medium for storing electronic data. The computer program product can comprise computer-readable code, (defining a computer program) which when loaded in a computer or computer system causes the computer or computer system to carry out the different methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The preceding description of preferred embodiments of the invention have been presented for the purposes of illustration. The description provided is not intended to limit the invention to the particular forms disclosed or described. Modifications and variations will be readily apparent from the preceding description. As a result, it is intended that the scope of the invention not be limited by the detailed description provided herein.

1-24. (canceled)

25. A computer-based method for accessing, updating, and maintaining health records of a medical data and reporting system, the method comprising the steps of:
receiving a request, from a first device via a first communications path, to display health records, stored at a central server, at a first device, the request comprising patient identifying information associated with the health records and obtained from a computer-readable medium independent of the central server;
receiving, from a second device via a second communications path, authentication data, the second communications path being different from the first communications path, and the second device being different than the first device;
determining whether a match occurs between the authentication data and the patient identifying data and corresponding entries in the health records stored at the central server; and
in response to determining the match occurs, delivering at least a portion of the health records at the central server to the first device.

26. The method of claim 25, wherein the computer-readable medium comprises at least one of an optically readable disk, barcode, magnetic strip, radio frequency tag, or other computer-readable medium, each containing a patient identifier, patient information, and medical history.

27. The method of claim 25, wherein the first device comprises a reader system configured for the obtaining of the patient identifying information from the computer-readable medium.

28. The method of claim 27, the reader system comprising at least one of a barcode reader, a magnetic stripe reader, or a radio frequency reader.

29. The method of claim 25, wherein the second device comprises a telephony device, wherein the authentication data comprises at least one among a patient identifier, a caller identifier associated with the telephony device, or a hospital identifier.

30. The method of claim 29, wherein the caller identifier comprises caller information associated with the telephony device.

31. The method of claim 29, wherein receiving of the authentication information comprises establishing a voice call session for receiving at least a portion of the authentication information.

32. The method of claim 31, wherein the voice call session is selected to provide a voice response system session configured to prompt a caller associated with the telephony device to communicate a patient identifier printed on a computer-readable medium.

33. The method of claim 25, wherein further in response to determining the match occurs, updating the health records at the central server in response to updated data being provided at the first device.

34. A system for accessing, updating, and maintaining health records of a medical data and reporting system, the system comprising:
a processor; and
at least one module, having stored thereon a plurality of instructions for causing the processor to carry out the method comprising:
receiving a request, from a first device via a first communications path, to display health records, stored at a central server, at a first device, the request comprising patient identifying information associated with the health records and obtained from a computer-readable medium independent of the central server;
receiving, from a second device via a second communications path, authentication data, the second communications path being different from the first communications path, and the second device being different than the first device;
determining whether a match occurs between the authentication data and the patient identifying data and corresponding entries in the health records stored at the central server; and
in response to determining the match occurs, delivering at least a portion of the health records at the central server to the first device.

35. The system of claim 34, wherein the second device comprises a telephony device, wherein the authentication data comprises at least one among a patient identifier, a caller identifier associated with the telephony device, or a hospital identifier.

36. The system of claim 35, wherein the caller identifier comprises caller information associated with the telephony device.

37. The system of claim 35, wherein receiving of the authentication information comprises establishing a voice call session for receiving at least a portion of the authentication information.

38. The system of claim 37, wherein the voice call session is selected to provide a voice response system session configured to prompt a caller associated with the telephony device to communicate a patient identifier printed on a computer-readable medium.

39. The method of claim 34, wherein further in response to determining the match occurs, updating the health records at the central server in response to updated data being provided at the first device.

40. A non-transitory computer-readable storage having stored therein computer-readable instructions, which, when loaded in and executed by a computer causes the computer to perform the steps of:
receiving a request, from a first device via a first communications path, to display health records, stored at a central server, at a first device, the request comprising patient identifying information associated with the health records and obtained from a computer-readable medium independent of the central server;
receiving, from a second device via a second communications path, authentication data, the second communications path being different from the first communications path, and the second device being different than the first device;
determining whether a match occurs between the authentication data and the patient identifying data and corresponding entries in the health records stored at the central server; and
in response to determining the match occurs, delivering at least a portion of the health records at the central server to the first device.

41. The computer-readable storage of claim 40, wherein the second device comprises a telephony device, wherein the authentication data comprises at least one among a patient identifier, a caller identifier associated with the telephony device, or a hospital identifier.

42. The computer-readable storage of claim 41, wherein the caller identifier comprises caller information associated with the telephony device.

43. The computer-readable storage of claim 41, wherein receiving of the authentication information comprises establishing a voice call session for receiving at least a portion of the authentication information.

44. The computer-readable storage of claim 43, wherein the voice call session is selected to provide a voice response system session configured to prompt a caller associated with the telephony device to communicate a patient identifier printed on a computer-readable medium.

45. The computer-readable storage of claim 40, wherein further in response to determining the match occurs, updating the health records at the central server in response to updated data being provided at the first device.
